(19) United States
(12) Patent Application Publication
(10) Pub. No.: US 2025/0329963 A1
(43) Pub. Date: Oct. 23, 2025

(54) CONNECTOR ASSEMBLY

(71) Applicant: Bellwether Electronic Corp., Taoyuan City (TW)

(72) Inventor: Yung-Liang CHI, Taoyuan City (TW)

(21) Appl. No.: 18/793,956

(22) Filed: Aug. 5, 2024

(30) Foreign Application Priority Data
Apr. 17, 2024 (TW) 113114362

(51) Int. Cl. H01R 13/633; H01R 13/627

(52) U.S. Cl. CPC H01R 13/633; H01R 13/6272

(57) ABSTRACT

A connector assembly includes a socket connector, a plug connector, a pulling member, and a redirecting portion located at one side of the plug connector. The socket connector includes a socket body, a buckle groove, and positioning ribs located on the socket body. The plug connector includes a plug body pluggably inserted into a socket slot of the socket body, an elastic arm extending from the plug body, and a buckle portion located on the elastic arm. The pulling member is connected to the plug connector, and passes the elastic arm and the redirecting portion to extend outwards from the plug body. When the pulling member is pulled, and the redirecting portion changes a pulling direction of the pulling member, the pulling member presses the elastic arm to disengage the buckle portion from the buckle groove and separate the plug body from the socket slot.

### RELATED APPLICATIONS

This application claims the benefit of Taiwan Application Serial Number 113114362 filed on Apr. 17, 2024, which is herein incorporated by reference in its entirety.

### BACKGROUND

### Field of Invention

The present disclosure relates to a connector assembly. More particularly, the present disclosure relates to a connector assembly helpful for being unplugged within a narrow space.

### Description of Related Art

Generally, electrical connectors have been widely used in various electronic equipment. After a socket connector in an electronic equipment and a plug connector are mated with each other, an electrical connection can be formed between the plug connector and the electronic equipment.

However, when the plug connector is mated with the socket connector within a narrower operating space of electronic equipment, an issue of the plug connector being difficult to be unplugged from the socket connector is found.

Thus, the above-mentioned technology obviously still has inconveniences and defects, which are issues that the industry needs to solve urgently.

### SUMMARY

One aspect of the present disclosure is to provide a connector assembly for solving the difficulties mentioned above in the prior art.

In one embodiment of the present disclosure, a connector assembly provided includes a socket connector, a plug connector, a redirecting portion and a pulling member. The socket connector includes a socket body, a buckle groove, at least one first positioning rib and at least one second positioning rib. One side surface of the socket body is formed with a socket slot, the buckle groove is disposed on the socket body, and the first positioning rib and the second positioning rib are located on an outer surface of the socket body for clamping a frame body of the fan module. The plug connector includes a plug body pluggably inserted into the socket slot, an elastic arm extending outwards from the plug body, and a buckle portion located on the elastic arm and used to buckle into the buckle groove. The redirecting portion is located at one side of the plug connector facing away from the socket slot. The pulling member is flexible, and connected to the plug connector, and passes the redirecting portion to extend outwards from the plug body. When the pulling member is pulled, a pulling direction of the pulling member is able to be changed by the redirecting portion, so that the pulling member presses the elastic arm to allow the buckle portion to disengage from the buckle groove so as to allow the plug body to be apart from the socket slot.

According to one or more embodiments of the present disclosure, in the aforementioned connector assembly, the socket slot is defined with an inner guide portion that includes a first guide surface and two second guide surfaces, and the first guide surface and the second guide surfaces are used to jointly guide the plug body into the socket slot.

According to one or more embodiments of the present disclosure, in the aforementioned connector assembly, the first positioning rib and the second positioning rib are alternately arranged with each other, the frame body is formed with an installation opening has at least one position-limited recess thereon. The socket connector is inserted into the installation opening, and the first positioning rib is inserted into the position-limited recess, and then the first positioning rib is moved laterally so that the frame body is sandwiched between the first positioning rib and the second positioning rib.

According to one or more embodiments of the present disclosure, in the aforementioned connector assembly, the socket connector includes an elastic piece and a protrusion. One end of the elastic piece is connected to one side surface of the socket body, and the other end is a free end, and the protrusion is convexly formed on one surface of the elastic piece facing towards the frame body, and the frame body is formed with an engagement recess. When the socket connector is inserted into the installation opening, the protrusion abuts against one surface of the frame body. When the first positioning rib moves laterally, the protrusion is moved laterally into and limited within the engagement recess from the frame body along with the socket body.

According to one or more embodiments of the present disclosure, in the aforementioned connector assembly, the plug connector includes a lug extending outwardly from one side of the plug body facing away from the socket slot, and the lug is formed with a split thereon, and the split serves as the redirecting portion.

According to one or more embodiments of the present disclosure, in the aforementioned connector assembly, the lug is integrally connected to the plug body.

According to one or more embodiments of the present disclosure, in the aforementioned connector assembly, the plug connector further includes a cover body detachably combined with the plug body, and the lug extends outwardly from one side of the cover body.

According to one or more embodiments of the present disclosure, in the aforementioned connector assembly, the elastic arm includes a first end and a second end which are opposite to each other, the first end is connected to one surface of the plug body, and a gap is formed between the second end of the elastic arm and the one surface of the plug body. The pulling member abuts against the second end of the elastic arm, passes downwardly through the split from the second end of the elastic arm, and guided by the split to redirect the pulling direction of the pulling member.

According to one or more embodiments of the present disclosure, in the aforementioned connector assembly, one end of the pulling member is buckled with the second end of the elastic arm.

According to one or more embodiments of the present disclosure, in the aforementioned connector assembly, one end of the pulling member is connected to a crossbar of the plug body, and the crossbar laterally extends above the elastic arm, and located between the buckle portion and the second end of the elastic arm.

According to one or more embodiments of the present disclosure, in the aforementioned connector assembly, the redirecting portion includes a connecting rib exactly located on a rear side of the plug connector relative to the socket connector, and separated from the plug body. A long axis direction of the connecting rib intersects an extending direction of the pulling member.

According to one or more embodiments of the present disclosure, in the aforementioned connector assembly, the elastic arm includes a first end and a second end which are opposite to each other, the first end is connected to one surface of the plug body, a gap is formed between the second end of the elastic arm and the one surface of the plug body, and the second end of the elastic arm is located between the connecting rib and the first end of the elastic arm, and higher than the connecting rib. The pulling member abuts against the second end of the elastic arm, passes through the connecting rib obliquely from the second end of the elastic arm, and guided by the connecting rib to redirect the pulling direction of the pulling member.

In one embodiment of the present disclosure, a connector assembly provided includes a socket connector, a plug connector, a redirecting portion and a pulling member. The socket connector includes a socket body and a buckle groove. One side surface of the socket body is formed with a socket slot, the buckle groove is disposed on the socket body, and the socket slot is provided with an inner guide portion connected to the side surface of the socket body and the socket body is mounted on the fan module. The plug connector includes a plug body, an elastic arm and a buckle portion. The plug body is pluggably inserted into the socket slot. The elastic arm is extended outwards from the surface of the plug body, and the buckle portion located on the elastic arm for buckling into the buckle groove. The redirecting portion is located at one of an independent object and the plug connector. The pulling member is flexible, and connected to the plug connector, and passes through the redirecting portion to extend outwards from the plug body. When the pulling member is pulled, a pulling direction of the pulling member is able to be changed by the redirecting portion, so that the pulling member presses the elastic arm to allow the buckle portion to disengage from the buckle groove so as to allow the plug body to be apart from the socket slot.

According to one or more embodiments of the present disclosure, in the aforementioned connector assembly, the socket connector further includes at least one first positioning rib and at least one second positioning rib that are alternately arranged for sandwiching a frame of the fan module there between.

According to one or more embodiments of the present disclosure, in the aforementioned connector assembly, the plug connector includes a lug extending outwardly from one side of the plug body facing away from the socket slot, and the lug is formed with a split thereon, and the split serves as the redirecting portion.

According to one or more embodiments of the present disclosure, in the aforementioned connector assembly, the elastic arm includes a first end and a second end which are opposite to each other, the first end is connected to the surface of the plug body, and a gap is formed between the second end of the elastic arm and the surface of the plug body. The pulling member abuts against the second end of the elastic arm, passes downwardly through the split from the second end of the elastic arm, and guided by the split to redirect the pulling direction of the pulling member.

According to one or more embodiments of the present disclosure, in the aforementioned connector assembly, one end of the pulling member is buckled with the second end of the elastic arm.

According to one or more embodiments of the present disclosure, in the aforementioned connector assembly, one end of the pulling member is connected to a crossbar of the plug body, and the crossbar laterally extends above the elastic arm, and located between the buckle portion and the second end of the elastic arm.

According to one or more embodiments of the present disclosure, in the aforementioned connector assembly, the redirecting portion includes a connecting rib exactly located on a rear side of the plug connector relative to the socket connector, and separated from the plug body. A long axis direction of the connecting rib intersects an extending direction of the pulling member.

According to one or more embodiments of the present disclosure, in the aforementioned connector assembly, the elastic arm includes a first end and a second end which are opposite to each other, the first end is connected to one surface of the plug body, a gap is formed between the second end of the elastic arm and the one surface of the plug body, and the second end of the elastic arm is located between the connecting rib and the first end of the elastic arm, and higher than the connecting rib. The pulling member abuts against the second end of the elastic arm, passes through the connecting rib obliquely from the second end of the elastic arm, and guided by the connecting rib to redirect the pulling direction of the pulling member.

Thus, through the construction of the embodiments above, the connector assembly of the disclosure is able to meet the purpose of pulling out the electrical connector from the socket smoothly under the restriction of a narrower operating space of electronic equipment.

The above description is merely used for illustrating the problems to be resolved, the technical methods for resolving the problems and their efficacies, etc. The specific details of the present disclosure will be explained in the embodiments below and related drawings.

### BRIEF DESCRIPTION OF THE DRAWINGS

The invention can be more fully understood by reading the following detailed description of the embodiment, with reference made to the accompanying drawings as follows:

FIG. 1 is a perspective view of a connector assembly according to one embodiment of the present disclosure.

FIG. 2A is an exploded view of a socket connector and a plug connector shown in FIG. 1.

FIG. 2B is the exploded view of FIG. 2A viewed from different perspective views.

FIG. 3 is an exploded view of the connector assembly of FIG. 1.

FIG. 4 is a cross-sectional view of the connector assembly viewed along a line AA of FIG. 1.

FIG. 5A and FIG. 5B are sequential operation schematic views of the embodiment of the present disclosure.

FIG. 6 is a perspective view of a connector assembly according to one embodiment of the present disclosure.

FIG. 7A is a cross-sectional view of the connector assembly viewed along a line BB of FIG. 6.

FIG. 7B is an operation schematic view of the buckle portion in FIG. 7A being separated from the buckle groove.

FIG. 8 is a perspective view of a plug connector according to one embodiment of the present disclosure.

FIG. 9 is a side view of a plug connector according to one embodiment of the present disclosure.

### DETAILED DESCRIPTION

Reference will now be made in detail to the present embodiments of the present disclosure, examples of which are illustrated in the accompanying drawings. Wherever possible, the same reference numbers are used in the drawings and the description to refer to the same or like parts. According to the embodiments, it will be apparent to those skilled in the art that various modifications and variations can be made to the structure of the present disclosure without departing from the scope or spirit of the present disclosure.

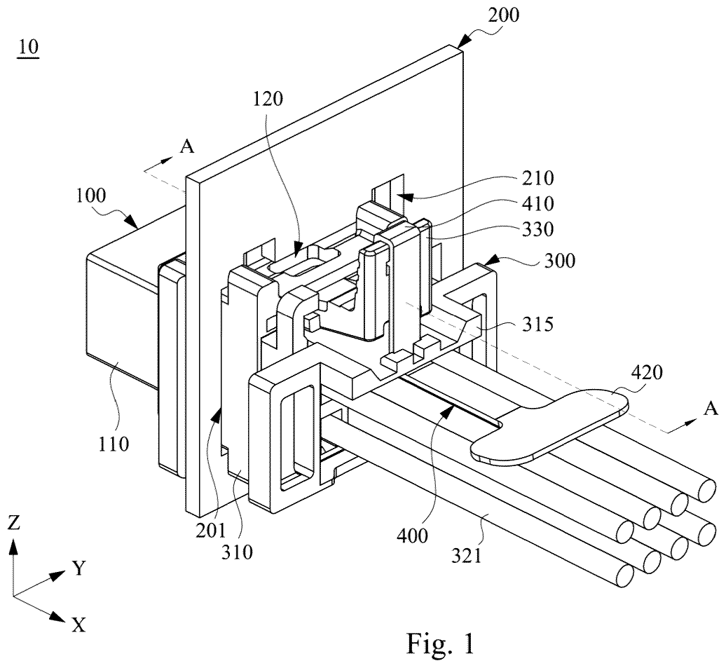

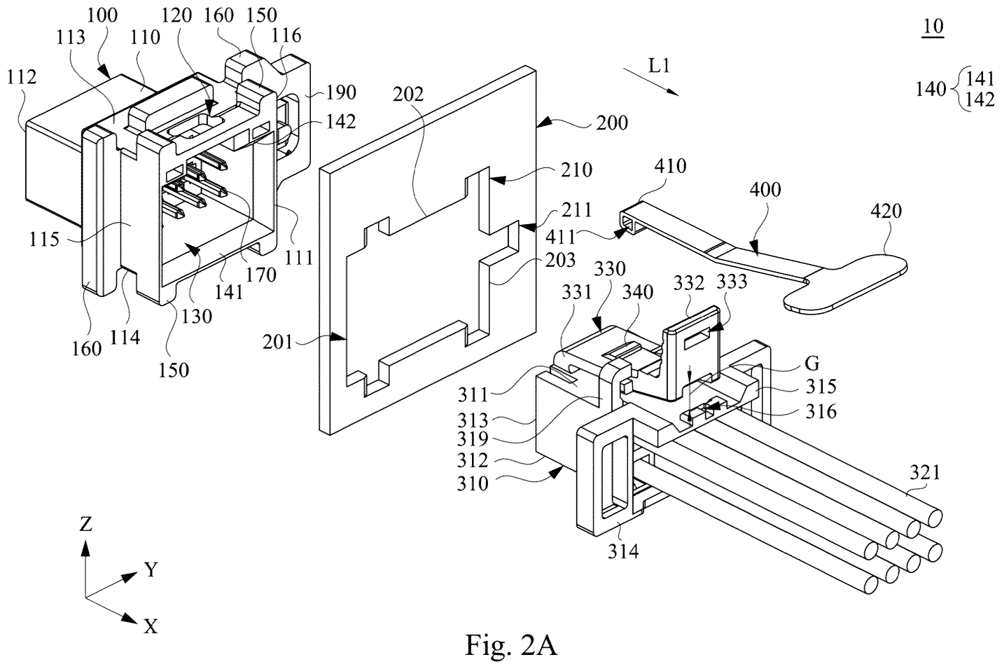

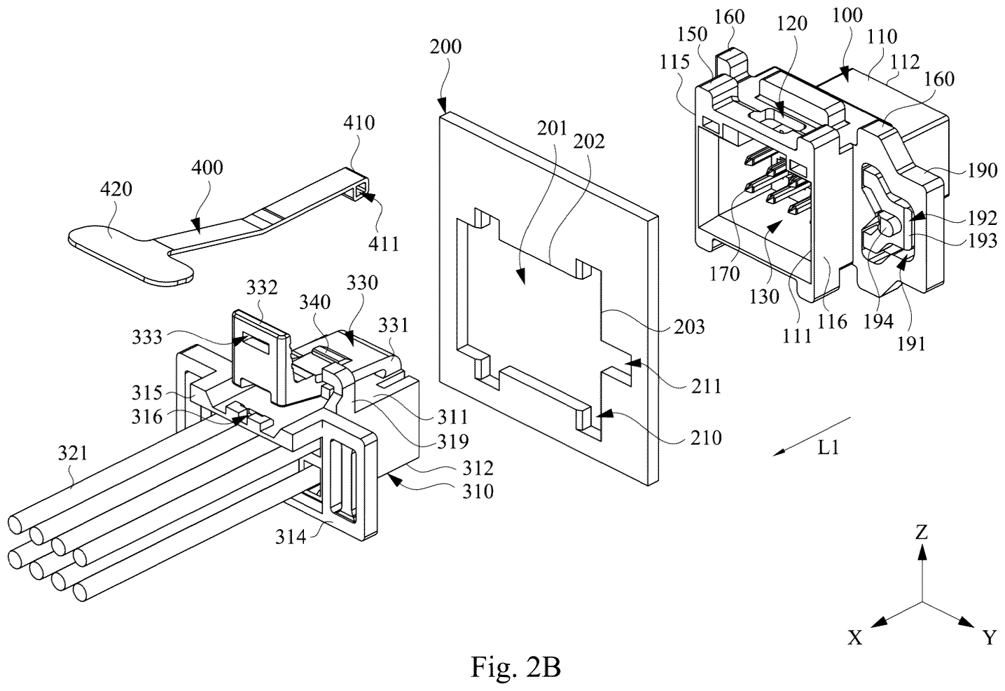

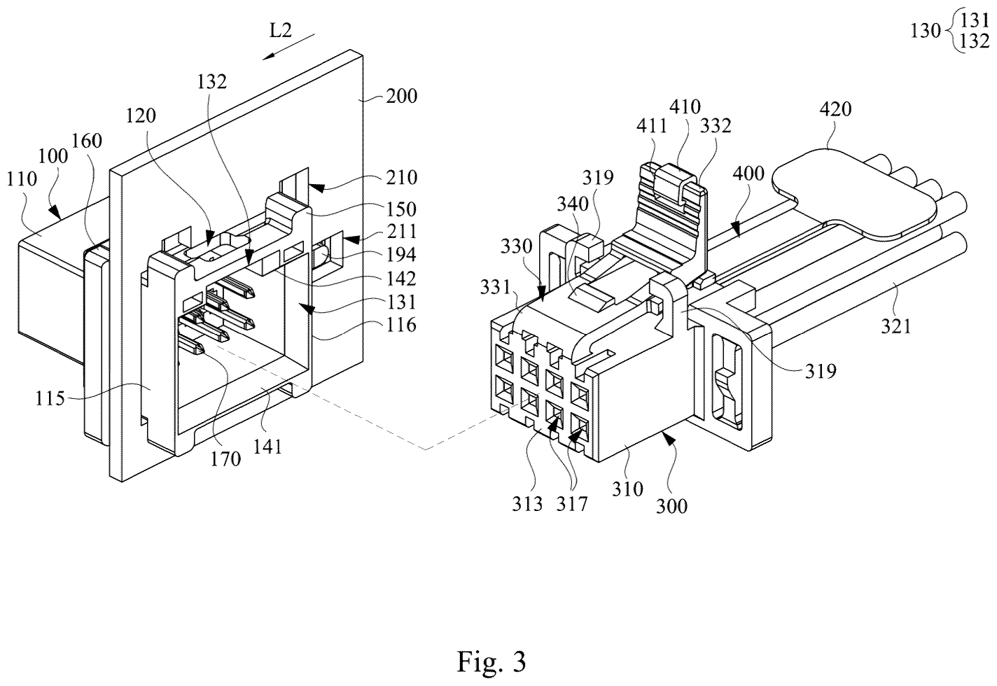

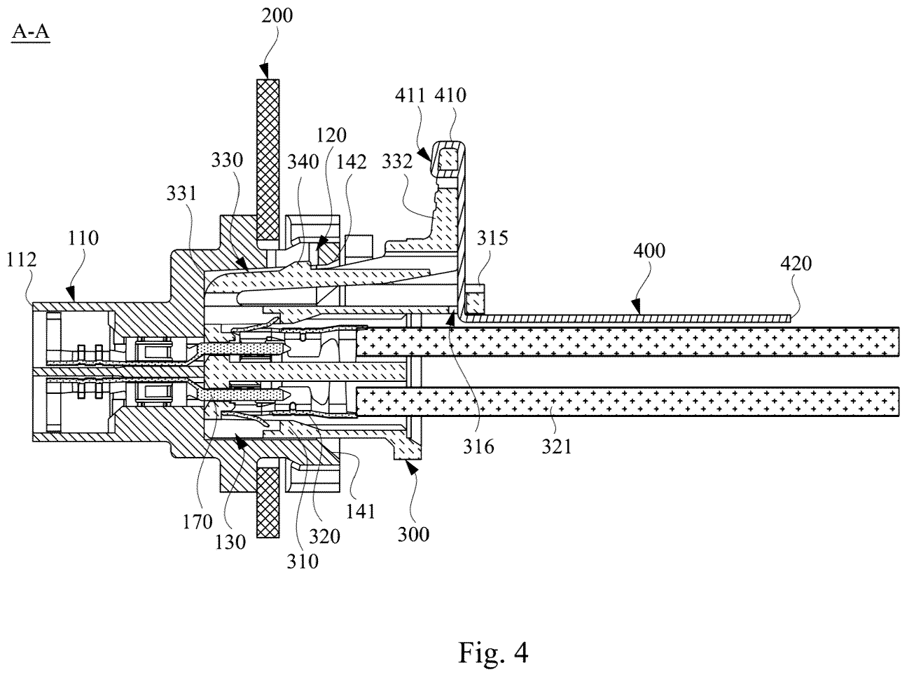

Reference is now made to FIG. 1 to FIG. 4, in which FIG. 1 is a perspective view of a connector assembly 10 according to one embodiment of the present disclosure, FIG. 2A is an exploded view of a socket connector 100 and a plug connector 300 shown in FIG. 1, FIG. 2B is the exploded view of FIG. 2A viewed from different perspective views, FIG. 3 is an exploded view of the connector assembly 10 of FIG. 1, and FIG. 4 is a cross-sectional view of the connector assembly 10 viewed along a line AA of FIG. 1.

As shown in FIG. 1 to FIG. 2A, a connector assembly 10 includes a socket connector 100, a plug connector 300, a redirecting portion (e.g., split 316) and a pulling member 400. The socket connector 100 includes a socket body 110, a socket slot 130, an inner guide portion 140 and a buckle groove 120. The socket body 110 includes a front side surface 111 and a rear side surface 112 which are opposite to each other. The socket body 110 is further provided with a plurality of first conductor terminals 170 therein. The socket slot 130 is formed on the front side surface 111 of the socket body 110, and the first conductor terminals 170 are fixed within the socket slot 130. The inner guide portion 140 is disposed in the socket slot 130, and connected to the front side surface 111 of the socket body 110. The buckle groove 120 is formed on the socket body 110, and in communication with the aforementioned socket slot 130 (FIG. 3).

As shown in FIG. 2A to FIG. 3, the plug connector 300 includes a plug body 310, an elastic arm 330 and a buckle portion 340. The plug body 310 includes a top surface 311 and a bottom surface 312 which are opposite to each other. The elastic arm 330 extends outwards from the top surface 311 of the plug body 310. For example, the elastic arm 330 is in an L shape, and the elastic arm 330 includes a first end 331 and a second end 332 which are opposite to each other. The first end 331 of the elastic arm 330 is connected to the top surface 311 of the plug body 310, and a gap G (FIG. 2A) is formed between the second end 332 of the elastic arm 330 and the top surface 311 of the plug body 310. The buckle portion 340 is disposed on the elastic arm 330. In the embodiment, the buckle portion 340 is protrusively formed from one surface of the elastic arm 330 facing away from the plug body 310. Furthermore, the plug body 310 is further provided with a plurality of second conductor terminals 320 (FIG. 4) therein. The second conductor terminals 320 and the first conductor terminals 170 are respectively aligned with each other. Each of the second conductor terminal 320 is connected to a wire 321, and located within one of through holes 317 of the plug body 310.

As shown in FIG. 2A to FIG. 4, when the plug connector 300 and the socket connector 100 are mated with each other, a front end 313 of the plug body 310 is pluggably extended into the socket slot 130 so that the second conductor terminals 320 can be respectively connected to the corresponding first conductor terminals 170. As the plug body 310 is plugged into the socket slot 130 to an anchor point, the buckle portion 340 of the elastic arm 330 also can be buckled into the buckle groove 120, so that the plug body 310 can be position-limited within the socket slot 130.

More specifically, as shown in FIG. 2A and FIG. 3, the aforementioned socket slot 130 is further defined with a first zone 131 and a second zone 132. The second zone 132 is located between the first zone 131 and the buckle groove 120, and smaller than the first zone 131. The second zone 132 is in communication with the first zone 131 and the buckle groove 120, respectively. When the plug body 310 is plugged into the socket slot 130 of the socket body 110, the first zone 131 is used to receive at least one part of the plug body 310, and the second zone 132 is used to receive at least one part of the elastic arm 330.

The inner guide portion 140 includes a first guide surface 141 and two second guide surfaces 142. The first guide surface 141 and the second guide surfaces 142 are arranged opposite to each other, the second zone 132 is interposed between the second guide surfaces 142, and the first zone 131 is interposed between the first guide surface 141 and the second guide surfaces 142. Thus, the first guide surface 141 and the second guide surfaces 142 are able to jointly guide the plug body 310 to extend into the socket slot 130 so that the plug body 310 can extend into the socket slot 130 more smoothly and correctly.

As shown in FIG. 2A and FIG. 2B, the socket connector 100 further includes a plurality (e.g., four) of first positioning ribs 150, a plurality of second positioning ribs 160 and an extension frame 190 so that the socket connector 100 can be installed on a frame body 200. For example, the first positioning ribs 150 are spaced apart from each other on the socket body 110, and each of the first positioning ribs 150 is protrusively formed on an outer surface of the socket body 110. These first positioning ribs 150 are all located on a first plane, where the first plane is a plane perpendicular to the X-axis (e.g., YZ plane). One of the second positioning ribs 160 and the extension frame 190 are oppositely protruded on the outer side of the socket body 110, and another two of the second positioning ribs 160 are oppositely located on the extension frame 190. The second positioning ribs 160 and the extension frame 190 are both located on a second plane being parallel to the first plane, and the second plane is separated from the first plane by a gap. The second positioning ribs 160 and the first positioning ribs 150 are alternately arranged with each other in the Y-axis, and the second positioning rib 160 is separated from the first positioning rib 150 by the gap on the X-axis, and this gap is approximately equal to the thickness of the frame body 200.

Furthermore, the socket body 110 is further provided with a left side surface 115 and a right side surface 116 which are opposite to each other. The left side surface 115 is located between the front side surface 111 and the rear side surface 112 of the socket body 110, and the right side surface 116 is located between the front side surface 111 and the rear side surface 112 of the socket body 110. The second positioning ribs 160 are respectively disposed on the left side surface 115 and the right side surface 116 of the socket body 110. The extension frame 190 is located on the right side surface 116 of the socket body 110. The extension frame 190 includes a piece notch 191, an elastic piece 192 and a protrusion 194. One end of the elastic piece 192 is connected to the right side surface 116 of the socket body 110. More specifically, the elastic piece 192 is disposed within the piece notch 191, and one end of the elastic piece 192 is connected to an inner wall of the piece notch 191, and the other end is a free end 193, and the protrusion 194 is convexly formed on one surface of the elastic piece 192 facing towards the frame body 200.

For example, the frame body 200 is a frame body of a fan module (not shown in figures), and an installation opening 201 is formed on the frame body 200. The installation opening 201 is formed with two first inner edges 202 which are opposite to each other, and two second inner edges 203 which are opposite to each other. Each of the first inner edges 202 is adjoined to the second inner edges 203, and each of the second inner edges 203 is adjoined to the first inner edges 202. The first inner edge 202 of the installation opening 201 is recessed with at least one position-limited recess 210 thereon, and the second inner edge 203 of the installation opening 201 is recessed with at least one engagement recess 211 thereon.

Furthermore, the socket body 110 is further provided with an upper side surface 113 and a lower side surface 114 which are opposite to each other. The upper side surface 113 is disposed between the front side surface 111 and the rear side surface 112 of the socket body 110, and between the left side surface 115 and the right side surface 116 of the socket body 110. The lower side surface 114 is located between the front side surface 111 and the rear side surface 112 of the socket body 110, and between the left side surface 115 and the right side surface 116 of the socket body 110. The first positioning ribs 150 are respectively disposed oppositely on the upper side surface 113 and the lower side surface 114 of the socket body 110 and jointly connected to the front side surface 111 of the socket body 110. The second positioning ribs 160 are respectively disposed oppositely on two sides of the socket body 110, and the second positioning ribs 160 are located between the front side surface 111 and the rear side surface 112 of the socket body 110.

In this way, when a user inserts the socket body 110 into the installation opening 201 of the frame body 200 along an insertion direction L1 (e.g., X-axis direction), the user synchronously moves the first positioning ribs 150 to pass through the corresponding position-limited recesses 210 respectively, therefore, the frame body 200 is located between the first positioning ribs 150 and the second positioning ribs 160 and between the first positioning ribs 150 and the extension frame 190, and the protrusion 194 located on the elastic piece 192 directly abuts one surface of the frame body 200; next, the user moves the socket body 110 in the installation opening 201 laterally along an engagement direction L2 (e.g., Y-axis direction), so that the first positioning ribs 150 will be laterally staggered away from the position-limited recesses 210, and the protrusion 194 on the elastic piece 192 will be laterally moved into the engagement recess 211. In this way, since the protrusion 194 on the elastic piece 192 is limited within the engagement recess 211, the frame body 200 can be sandwiched between the first positioning ribs 150 and the second positioning ribs 160, so that the socket body 110 can be toollessly fixed on the frame body 200.

Furthermore, as shown in FIG. 2A and FIG. 3, the redirecting portion (e.g., the split 316) is located at one side of the plug connector 300 facing away from the socket slot 130 (i.e., the front end 313 of the plug connector 300). For example, the split 316 is recessed on a rear end 314 of the plug body 310 facing away from the socket slot 130. The pulling member 400 is flexible as a strip member, and the pulling member 400 is connected to the elastic arm 330 and passes the redirecting portion (e.g., split 316) to extend outwards from the plug body 310.

More specifically, the pulling member 400 includes a fixed end 410 and a free end 420 which are opposite to each other. The fixed end 410 of the pulling member 400 is fixed to the second end 332 of the elastic arm 330. For example, the fixed end 410 of the pulling member 400 is provided with a clasping portion 411, and the second end 332 of the elastic arm 330 is provided with a grasping portion 333. The grasping portion 333 is used to grasp the clasping portion 411, and the pulling member 400 is a strip member such as a pull strap or a pull rope. However, the present disclosure is not limited to the form of the pulling member.

As shown in FIG. 2A and FIG. 3, the plug connector 300 includes a lug 315 extending outwardly from one side of the plug body 310 facing away from the socket slot 130, the aforementioned split 316 is formed on the lug 315 and penetrates through the lug 315. The second end 332 of the elastic arm 330 is located above the split 316, and staggered forward and backward from the split 316 in the X-axis direction. Alternatively, the second end 332 of the elastic arm 330 may at least partially overlap with the split 316 in a vertical direction (e.g., Z-axis direction, FIG. 4). In this way, the fixed end 410 of the pulling member 400 is directly connected to the second end 332 of the elastic arm 330, and one part of the pulling member 400 is passed downwardly from the second end 332 of the elastic arm 330, moved through the split 316, and redirected its extending direction (e.g., pulling directions F1, F2) after abutting against the split 316.

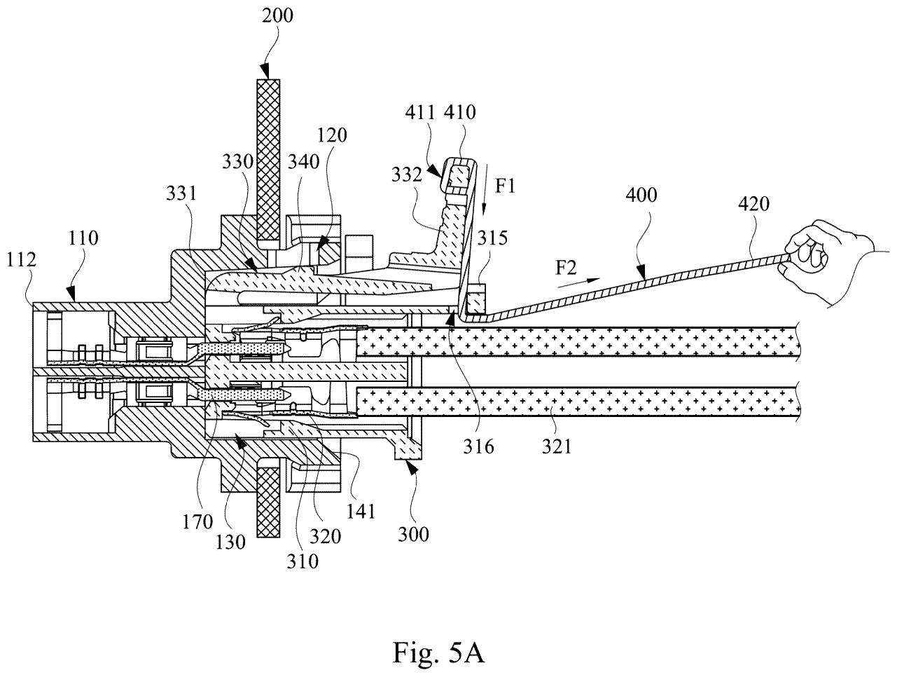

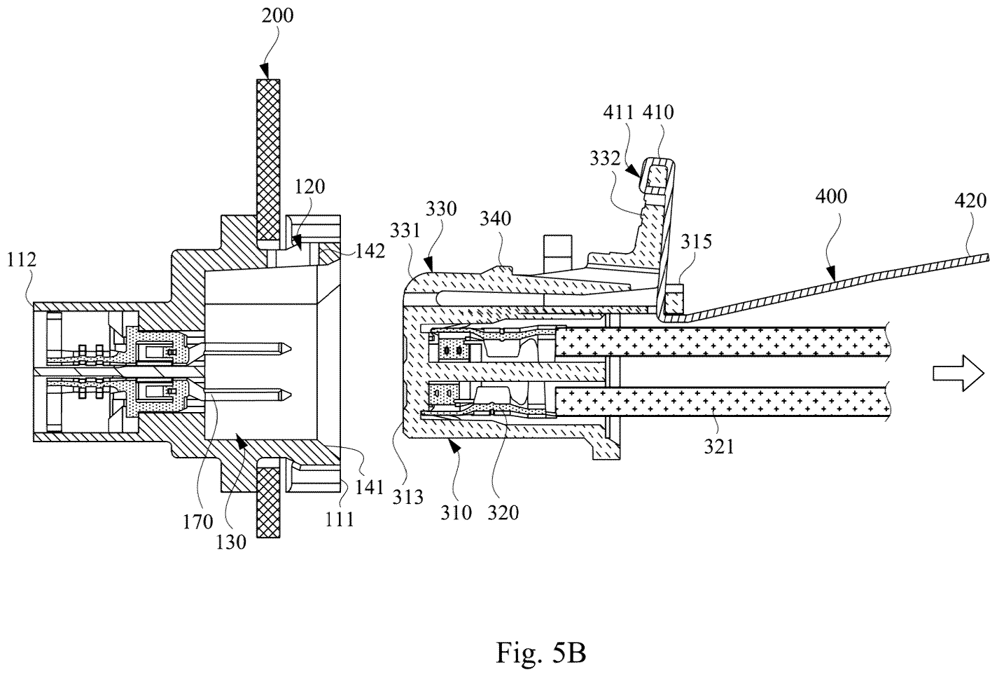

FIG. 5A and FIG. 5B are sequential operation schematic views of the embodiment of the present disclosure. As shown in FIG. 5A and FIG. 5B, when a user wants to separate the socket connector 100 and the plug connector 300, the user picks up the free end 420 of the pulling member 400 and pulls the pulling member 400 into a tension situation, because the split 316 changes the pulling directions F1 and F2 of the pulling member 400, the user's pulling force is directly converted into a downward pressure on the elastic arm 330 by the guide of the split 316 (e.g., an inner wall and an opening end of the split 316) so that the buckle portion 340 can be disengaged from the buckle groove 120 (FIG. 5A). Therefore, the user is able to completely unplug the plug body 310 away from the socket slot 130 of the socket body 110 (FIG. 5B).

In addition, the plug body 310 is further provided with two stop structures 319. Each of the stop structured 319 is L-shaped, and each of the stop structured 319 protrudes outwards from the top surface 311 of the plug body 310. The elastic arm 330 is located between these stop structures 319 and restricted between the stop structures 319 and the top surface 311 of the plug body 310 for stopping and limiting excessive rebound of the elastic arm 330. As shown in FIG. 3, in this embodiment, the lug 315 is connected to the plug body 310. More specifically, the lug 315 is integrally and protrusively formed on one side of the plug body 310 facing away from the socket slot 130, however, the present disclosure is not limited thereto. In other embodiments, the lug 315 may also be detachably disposed on the plug body 310, and will be explained in detail below.

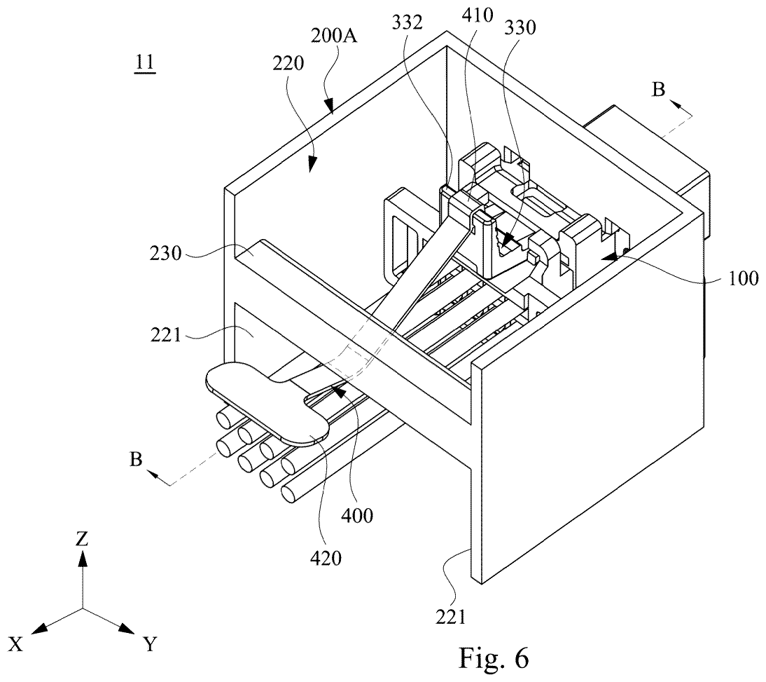

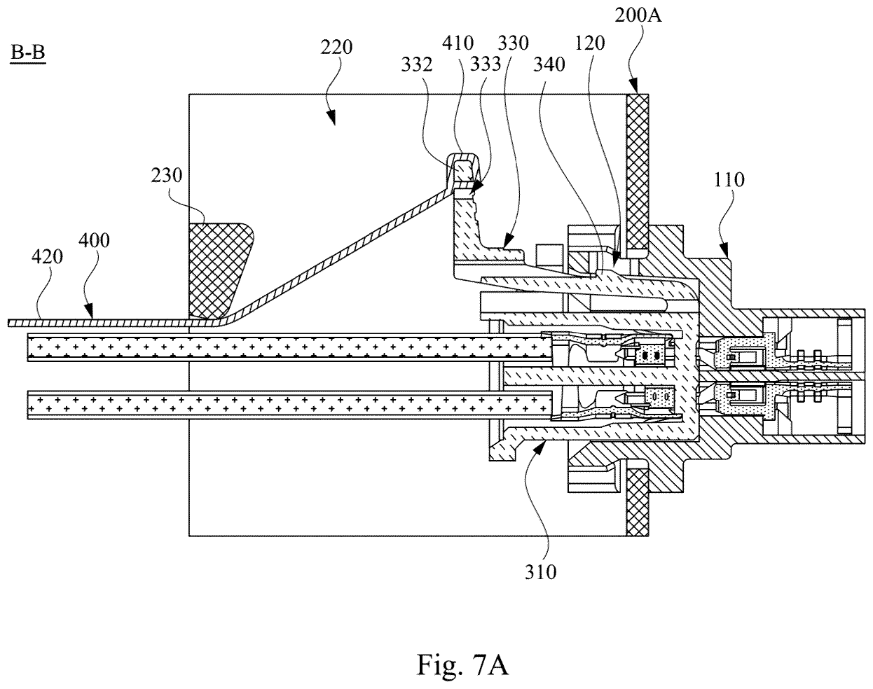

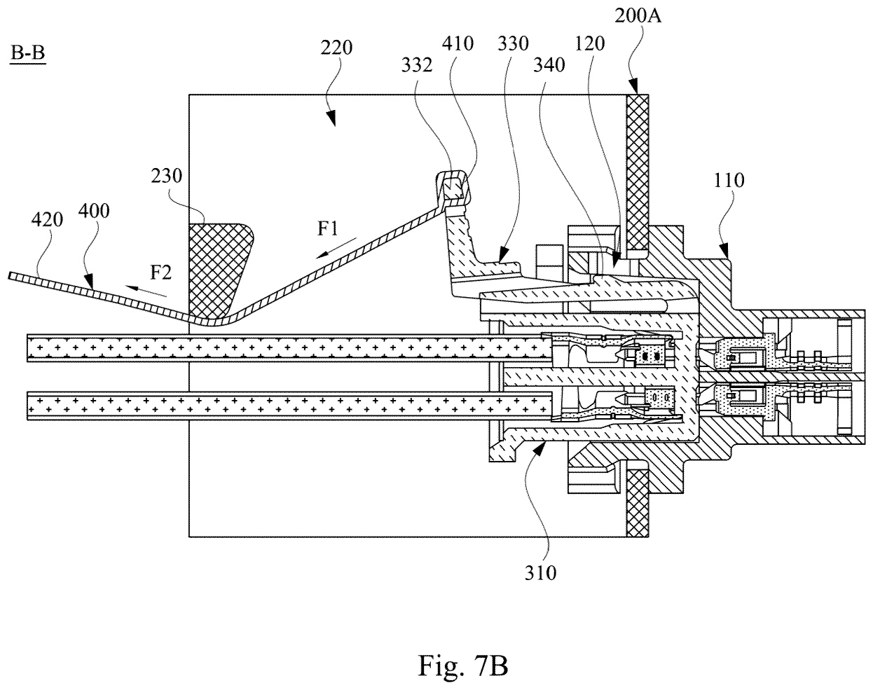

Reference is now made to FIG. 6 to FIG. 7B, in which FIG. 6 is a perspective view of a connector assembly 11 according to one embodiment of the present disclosure. FIG. 7A is a cross-sectional view of the connector assembly 11 viewed along a line BB of FIG. 6. FIG. 7B is an operation schematic view of the buckle portion 340 in FIG. 7A being separated from the buckle groove 120. As shown in FIG. 6 and FIG. 7A, the connector assembly 11 of the present embodiment and the connector assembly 10 of the above embodiment are substantially the same, except that compared to the redirecting portion located on the plug body 310 (FIG. 2A) mentioned above, the redirecting portion of the present embodiment can be a connecting rib 230 totally separated from the plug body and exactly behind the plug connector 300 relative to the socket connector 100, and a long axis direction of the connecting rib 230 intersects an extending direction (e.g., X-axis direction, FIG. 6) of the pulling member 400. In this embodiment, the frame body 200A is U-shaped, and the frame body 200A surrounds to form an internal space 220 used to receive the plug connector 300 and a part of the socket connector 100. The connecting rib 230 is located in the internal space 220 and respectively connected to two opposite inner walls 221 of the frame body 200A. The fixed end 410 of the pulling member 400 is directly fixed to the second end 332 of the elastic arm 330. One part of the pulling member 400 obliquely extends from the second end 332 of the elastic arm 330 to pass a lower edge of the connecting rib 230 (FIG. 7B), and then extends outwards from the frame body 200A after being redirected by the lower edge of the connecting rib 230 (FIG. 7B). The lower edge of the connecting rib 230 is lower than the grasping portion 333 of the second end 332 of the elastic arm 330 in the Z-axis direction.

Therefore, as shown in FIG. 7B, since the lower edge of the connecting rib 230 is arc-shaped, when a user picks up the free end 420 of the pulling member 400, the lower edge of the connecting rib 230 can guide the pulling member 400 to change its extending direction (e.g., pulling directions F1, F2), so that the buckle portion 340 can be disengaged from the buckle groove 120 (FIG. 5A).

It is noted, the connecting rib 230 served as the redirecting portion mentioned above does not have to be located on the frame body 200A. The redirecting portion in other embodiments can also be an independent object or one object physically connected to a socket connector or a plug connector.

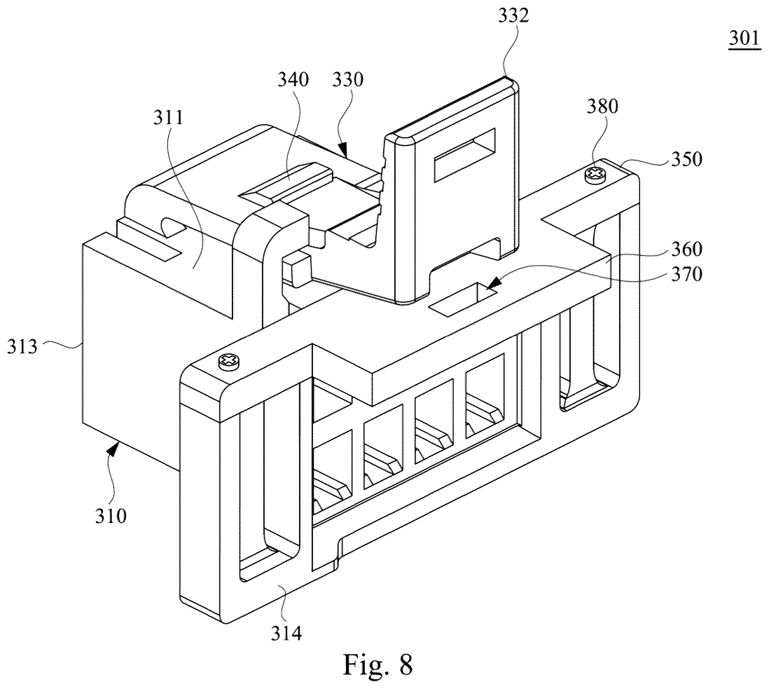

FIG. 8 is a perspective view of a plug connector 301 according to one embodiment of the present disclosure. As shown in FIG. 8, the plug connector 301 of the present embodiment and the plug connector 300 of the above embodiments are substantially the same, except that the lug 360 is not integrally connected to the plug body 310, but detachable on the plug body 310 to flexibly enhance the design of the plug connector 301.

More specifically, the plug connector 301 further includes a cover body 350 detachably combined with the plug body 310, and located at the rear end 314 of the plug body 310. For example, the cover body 350 is secured on the plug body 310 through bolts 380. However, the present disclosure is not limited thereto. The lug 360 protrudes from one side of the cover body 350 facing away from the socket body 110, and the split 370 is formed to penetrate through the cover body 350.

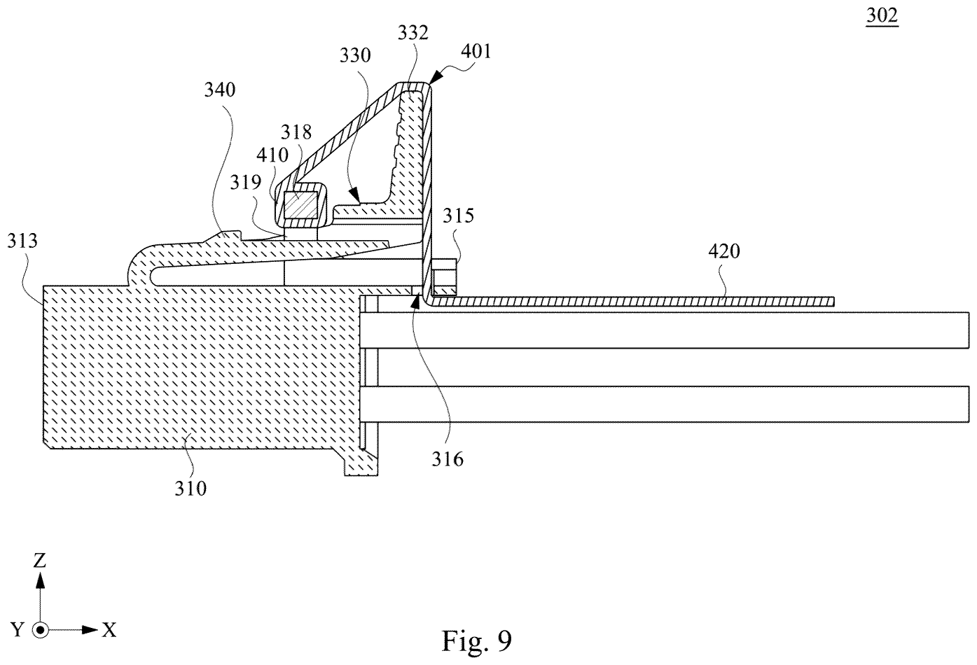

FIG. 9 is a side view of a plug connector 302 according to one embodiment of the present disclosure. As shown in FIG. 9, the pulling member 401 of the present embodiment and the pulling member 400 of the above embodiments are substantially the same, except that compared to the fixed end 410 of the pulling member 400 directly connected to the second end 332 of the elastic arm 330 (FIG. 4) in the above embodiment, as shown in FIG. 9, the pulling member 401 of this embodiment is directly connected to a crossbar 318 of the plug body 310 with the fixed end 410, and passes over the top of the second end 332 of the elastic arm 330, and the pulling member 401 moves through the split 316 to redirect its extending direction after abutting against the split 316. The crossbar 318 laterally extends above the elastic arm 330 and located between the buckle portion 340 and the second end 332 of the elastic arm 330. More specifically, the crossbar 318 is laterally connected to the above-mentioned stop structures 319 (FIG. 3), and the long axis direction of the crossbar 318 and the Y-axis direction are parallel to each other. It is noted, in this embodiment, the pulling member 401 and the buckle portion 340 may be arranged in a staggered manner, or other measures may be adopted to satisfy the combination of the buckle portion 340 and the buckle groove 120.

In the above embodiments, the connector assembly is used in the fan module to provide power and signal transmission for the fan module. However, the present disclosure is not limited to this application field of the connector assembly. In this way, since the operating space in the fan module is extremely narrow, through the construction above, the present disclosure can meet the purpose of pulling out the electrical connector from the socket smoothly under the restriction of the narrower operating space of the fan module.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A connector assembly implemented to a fan module, comprising:
a socket connector comprising a socket body, a buckle groove, at least one first positioning rib and at least one second positioning rib, and one side surface of the socket body formed with a socket slot, the buckle groove disposed on the socket body, and the at least one first positioning rib and the at least one second positioning rib located on an outer surface of the socket body for clamping a frame body of the fan module;
a plug connector comprising a plug body pluggably inserted into the socket slot, an elastic arm extending outwards from the plug body, and a buckle portion located on the elastic arm and used to buckle into the buckle groove;
a redirecting portion located at one side of the plug connector facing away from the socket slot; and
a pulling member that is flexible, connected to the plug connector, and passing the redirecting portion to extend outwards from the plug body,
wherein when the pulling member is pulled, a pulling direction of the pulling member is able to be changed by the redirecting portion, so that the pulling member presses the elastic arm to disengage the buckle portion from the buckle groove for unplugging the plug body from the socket slot.

2. The connector assembly of claim 1, wherein the socket slot is defined with an inner guide portion that comprises a first guide surface and two second guide surfaces, and the first guide surface and the second guide surfaces are used to jointly guide the plug body into the socket slot.

3. The connector assembly of claim 1, wherein the at least one first positioning rib and the at least one second positioning rib are alternately arranged with each other, the frame body is formed with an installation opening having at least one position-limited recess thereon,
wherein the socket connector is inserted into the installation opening, and the at least one first positioning rib is inserted into the position-limited recess, and then the at least one first positioning rib is moved laterally so that the frame body is sandwiched between the at least one first positioning rib and the at least one second positioning rib.

4. The connector assembly of claim 3, wherein the socket connector comprises an elastic piece and a protrusion, one end of the elastic piece is connected to one side surface of the socket body and the other end is a free end, and the protrusion is convexly formed on one surface of the elastic piece facing towards the frame body, and the frame body is formed with an engagement recess,
wherein when the socket connector is inserted into the installation opening, the protrusion abuts against one surface of the frame body;
when the at least one first positioning rib moves laterally, the protrusion is moved laterally into and limited within the engagement recess from the frame body along with the socket body.

5. The connector assembly of claim 1, wherein the plug connector comprises a lug extending outwardly from one side of the plug body facing away from the socket slot, and the lug is formed with a split thereon, wherein the split serves as the redirecting portion.

6. The connector assembly of claim 5, wherein the lug is integrally connected to the plug body.

7. The connector assembly of claim 5, wherein the plug connector further comprises:
a cover body detachably combined with the plug body, wherein the lug extends outwardly from one side of the cover body.

8. The connector assembly of claim 5, wherein the elastic arm comprises a first end and a second end which are opposite to each other, the first end is connected to one surface of the plug body, and a gap is formed between the second end of the elastic arm and the one surface of the plug body,
wherein the pulling member abuts against the second end of the elastic arm, passes downwardly through the split from the second end of the elastic arm, and guided by the split to redirect the pulling direction of the pulling member.

9. The connector assembly of claim 8, wherein one end of the pulling member is buckled with the second end of the elastic arm.

10. The connector assembly of claim 8, wherein one end of the pulling member is connected to a crossbar of the plug body, and the crossbar laterally extends above the elastic arm, and located between the buckle portion and the second end of the elastic arm.

11. The connector assembly of claim 1, wherein the redirecting portion comprises a connecting rib exactly located on a rear side of the plug connector relative to the socket connector, and separated from the plug body,
wherein a long axis direction of the connecting rib intersects an extending direction of the pulling member.

12. The connector assembly of claim 11, wherein the elastic arm comprises a first end and a second end which are opposite to each other, the first end is connected to one surface of the plug body, a gap is formed between the second end of the elastic arm and the one surface of the plug body, and the second end of the elastic arm is located between the connecting rib and the first end of the elastic arm, and higher than the connecting rib,
wherein the pulling member abuts against the second end of the elastic arm, passes through the connecting rib obliquely from the second end of the elastic arm, and guided by the connecting rib to redirect the pulling direction of the pulling member.

13. A connector assembly implemented to a fan module, comprising:
a socket connector comprising a socket body and a buckle groove, one side surface of the socket body formed with a socket slot, the buckle groove disposed on the socket body, the socket slot provided with an inner guide portion connected to the one side surface of the socket body and the socket body mounted on the fan module;
a plug connector comprising a plug body, an elastic arm, and a buckle portion, the plug body pluggably inserted into the socket slot, the elastic arm extended outwards from the one surface of the plug body, and the buckle portion located on the elastic arm for buckling into the buckle groove;
a redirecting portion located at one of the plug connector and an independent object; and
a pulling member connected to the plug connector, and passing through the redirecting portion to extend outwards from the plug body,
wherein when the pulling member is pulled, a pulling direction of the pulling member is able to be changed by the redirecting portion, so that the pulling member presses the elastic arm to allow the buckle portion to disengage from the buckle groove so as to allow the plug body to be apart from the socket slot.

14. The connector assembly of claim 13, wherein the socket connector further comprises at least one first positioning rib and at least one second positioning rib that are alternately arranged for sandwiching a frame of the fan module there between.

15. The connector assembly of claim 13, wherein the plug connector comprises a lug extending outwardly from one side of the plug body away from the socket slot, and the lug is formed with a split thereon, wherein the split serves as the redirecting portion.

16. The connector assembly of claim 15, wherein the elastic arm comprises a first end and a second end which are opposite to each other, the first end is connected to the one surface of the plug body, and a gap is formed between the second end of the elastic arm and the one surface of the plug body,
wherein the pulling member abuts against the second end of the elastic arm, passes downwardly through the split from the second end of the elastic arm, and guided by the split to redirect the pulling direction of the pulling member.

17. The connector assembly of claim 16, wherein one end of the pulling member is buckled with the second end of the elastic arm.

18. The connector assembly of claim 16, wherein one end of the pulling member is connected to a crossbar of the plug body, and the crossbar laterally extends above the elastic arm, and located between the buckle portion and the second end of the elastic arm.

19. The connector assembly of claim 13, wherein the redirecting portion comprises a connecting rib exactly located on a rear side of the plug connector relative to the socket connector, and separated from the plug body,
wherein a long axis direction of the connecting rib intersects an extending direction of the pulling member.

20. The connector assembly of claim 19, wherein the elastic arm comprises a first end and a second end which are opposite to each other, the first end is connected to one surface of the plug body, a gap is formed between the second end of the elastic arm and the one surface of the plug body, and the second end of the elastic arm is located between the connecting rib and the first end of the elastic arm, and higher than the connecting rib,
wherein the pulling member abuts against the second end of the elastic arm, passes through the connecting rib obliquely from the second end of the elastic arm, and guided by the connecting rib to redirect the pulling direction of the pulling member.
